(19) United States
(12) Patent Application Publication
(10) Pub. No.: US 2010/0043716 A1
(43) Pub. Date: Feb. 25, 2010

(54) Animal-Controlled Water Dispensing Apparatus

(76) Inventor: Michael D. Klanke, Katy, TX (US)

Correspondence Address: TIM COOK, P.O. BOX 10107, LIBERTY, TX, 77575, US

(21) Appl. No.: 12/543,556

(22) Filed: Aug. 19, 2009

Related U.S. Application Data
(60) Provisional application No. 61/189,375, filed on Aug. 19, 2008.

(51) Int. Cl. A01K 7/00

(52) U.S. Cl. 119/75

(57) ABSTRACT

A water dispenser provides a water retaining bowl extending from a reservoir and defining a spring-loaded valve to dispense liquid, preferably fresh water or melted ice, into the bowl. The bowl also defines a threaded rod extending from the opposite end of the device to extend into the reservoir. The threaded rod receives a nut and washer to abut against the spring and hold the device against an outer wall of the reservoir. In use, a pet laps down against the bowl, thereby releasing water into the bowl. In this manner, the natural instinct of the pet is employed to operate the dispensing device.

This application claims the benefit of U.S. Provisional Application Ser. No. 61/189,375 filed Aug. 19, 2008.

### FIELD OF THE INVENTION

This invention relates generally to the field of water dispensing devices, particularly for pets. More particular, this invention relates to a portable water dispensing system for replenishing water from a reservoir as and when water is consumed by the pet.

### BACKGROUND OF THE INVENTION

Pet watering devices having self-replenishing features are well known, and generally comprise a bowl portion presenting an open top, a relatively shallow trough, and a water supply in the form of an inverted reservoir in communication with the bowl portion. In such devices, an outlet of the reservoir extends below an upper edge of the trough, so that atmospheric pressure exerted on the water in the open top trough operates to prevent release of water from the supply reservoir which would raise the level of water in the trough to greater than the height of the opening of the reservoir which extends just below a surface of the water in the bowl. As water is consumed to a level below the reservoir opening, water is replenished from the reservoir until the water in the bowl rises to a height to cover the opening.

This type of device works quite well but it has a number of limitations and difficulties attendant in the replacement of the water-filled reservoir, the complexity of parts, and the lack of portability.

Examples of such types of water dispensing devices are widely available on the commercial market, and an even larger number of these devices are known in the art, for example, the feeder dish for traveling animals disclosed by Buffum in U.S. Pat. No. 3,749,063; the combined feeding and watering device for pets disclosed by Clugston in U.S. Pat. No. 4,192,256; the pet water saver disclosed by Carrico in U.S. Pat. No. 5,297,504; the automatic portable drinking device for animals disclosed by Gavet in U.S. Pat. No. 5,809,934; the portable canine water dispenser and drinking device disclosed by O'Rourke et al. in U.S. Pat. No. 5,960,742; the animal watering system and methods disclosed by Bowell et al. in U.S. Pat. No. 6,079,361; the water dispensing device, kit and method disclosed by Rohrer in U.S. Pat. No. 6,971,331; and the water dispenser for a pet disclosed by Kolozsvari in U.S. Pat. No. D406.926.

While all of the above-described devices fulfill their respective, particular objectives and requirements, the aforementioned patents do not describe a portable pet watering device wherein the pet selectively induces and stops flow of the water.

Furthermore, none of the above inventions and patents, taken either singly or in combination, describe the present invention as claimed. It would therefore be desirable to provide a new water dispensing device described in detail below.

### BRIEF SUMMARY OF THE INVENTION

In view of the foregoing disadvantages in devices known in the art, the present invention provides a device for dispensing water which has novel features that result in a new pet watering device. The water dispensing device disclosed herein provides a water retaining bowl extending from a reservoir and defining a spring-loaded valve to dispense liquid, preferably fresh water or melted ice, into the bowl. The bowl also defines a threaded rod extending from the opposite end of the device to extend into the reservoir. The threaded rod receives a nut and washer to abut against the spring and hold the device against an outer wall of the reservoir. In use, a pet laps down against the bowl, thereby releasing water into the bowl. In this manner, the natural instinct of the pet is employed to operate the dispensing device.

In another aspect, the present invention comprises a bowl portion at one end of an outwardly extending member cooperating with a barrier member at the opposite end such that depressing the bowl portion allows a slight displacement of the barrier member to thereby induce the flow of water from a reservoir.

It is to be understood that the invention is not limited in this application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. Those skilled in the art will appreciate that the conception, upon which this disclosure is based, may readily be utilized as a basis for the designing of other devices, methods and systems for carrying out the several purposes of the present invention. The claims are to be regarded as including such equivalent constructions insofar as they do not depart from the spirit and scope of the present invention.

It is therefore an object of the present invention to provide a new and improved apparatus and method for dispensing water which is portable and relatively easy to use during family trips, outdoor activities and hunting adventures with a pet. Another object of the present invention is to provide a new and improved apparatus and method for dispensing water, which is of a relatively simple design and thus may be easily and efficiently manufactured.

An even further object of the present invention is to provide a new and improved apparatus and method for dispensing water which is of a more durable and reliable construction and can be used in a variety of settings as compared to the existing known art.

Still another object of the present invention is to provide a new and improved apparatus and method for dispensing water which is susceptible to a low cost of manufacture with regard to both materials and labor, which accordingly is then susceptible of low prices of sale to the consuming public, thereby making such economically available to those utilizing pet watering devices.

Another object of the present invention is to provide a new and improved apparatus and method for dispensing water that provides some of the advantages of the prior art, while simultaneously overcoming some of the disadvantages normally associated therewith. These together with other objects of the invention, along with the various features of novelty, which characterize the invention, are pointed out with particularity in the claims annexed to and forming a part of this disclosure. The above objects and advantages are neither exhaustive nor individually or jointly critical to the spirit or practice of the invention. Other aspects and advantages of the invention will become apparent to those skilled in the art from the following detailed description in combination with the accompanying drawings, illustrating, by way of example, the principles of the invention.

### BRIEF DESCRIPTION OF THE DRAWINGS

The invention will be better understood and objects other than those set forth above will become apparent when consideration is given to the following detailed description thereof. Such description makes reference to the annexed pictorial illustrations, graphs, drawings, and appendices.

FIG. 1 is a perspective view of a water dispensing device constructed in accordance with the present invention coupled to a reservoir retaining a quantity of a liquid.

FIG. 2 is a side section view of the water dispensing device, taken along section lines 2-2 of FIG. 1, extending through a wall of the reservoir, shown in a quiescent position.

FIG. 3 is a side section view of the water dispensing device extending through a wall of the reservoir, shown in a depressed position.

FIG. 4 is a section view of the water dispensing device taken along section lines 4-4 of FIG. 2.

FIG. 5 is a section view of the device taken along section lines 5-5 of FIG. 2.

### DETAILED DESCRIPTION OF A PREFERRED EMBODIMENT

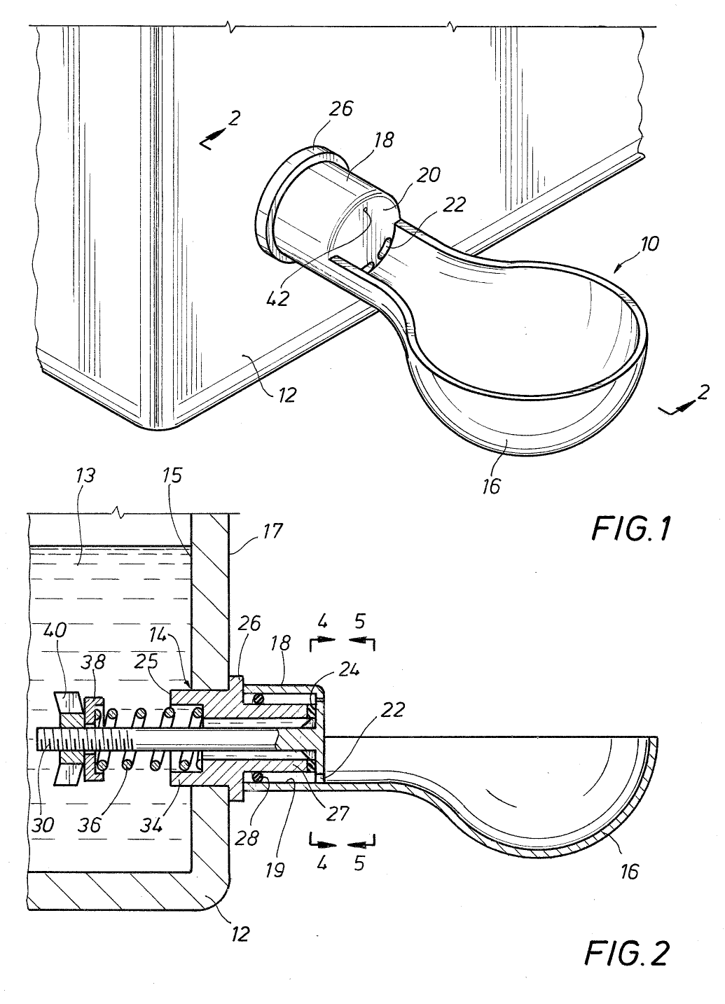

Referring to FIGS. 1 through 5, a currently preferred embodiment of a water dispensing device 10, constructed in accordance with the present invention, is illustrated. As shown, the water dispensing device cooperates with a reservoir 12 to hold a quantity of water 13, or any other liquid. The reservoir may be any suitable container, such as an insulated cooler or ice chest, having a drain plug opening 14 (see FIG. 2) and defining an interior wall 15 and an exterior wall 17. Moreover, the watering device 10 may be formed of any suitable flexible material, for example low-density or medium-density plastic, rubber or the like.

In a preferred construction, the device may be selectively disposed into, or removed from, the reservoir drain plug opening 14 for the purpose of allowing the water, melted ice, or any other liquid to flow from the reservoir as induced by the pet, the method of which will be explained in more detail below.

The water dispensing device may be formed to include a bowl 16 facing upward so as to retain a quantity of a liquid. A barrier member 18 is positioned at the opposite end of the water dispensing device from the bowl. The barrier member 18 includes a wall 20 to retain the water within the bowl and to retain liquid within the reservoir and further defines an inside surface 19. One or more holes 22 are formed in the wall 20 to selectively allow liquid to flow into the bowl. It is contemplated that the means of attaching the water dispensing device to the reservoir may be by any suitable means, including, but not limited to, frictional, threaded, press fit and so forth. The water dispensing device further includes at least one sealing ring, “0-ring,” or gasket 24 for the purpose of providing a positive seal between the watering device and the reservoir. The gasket 24 preferably a flat polymeric washer affixed to the inside surface 19 of the barrier member 18.

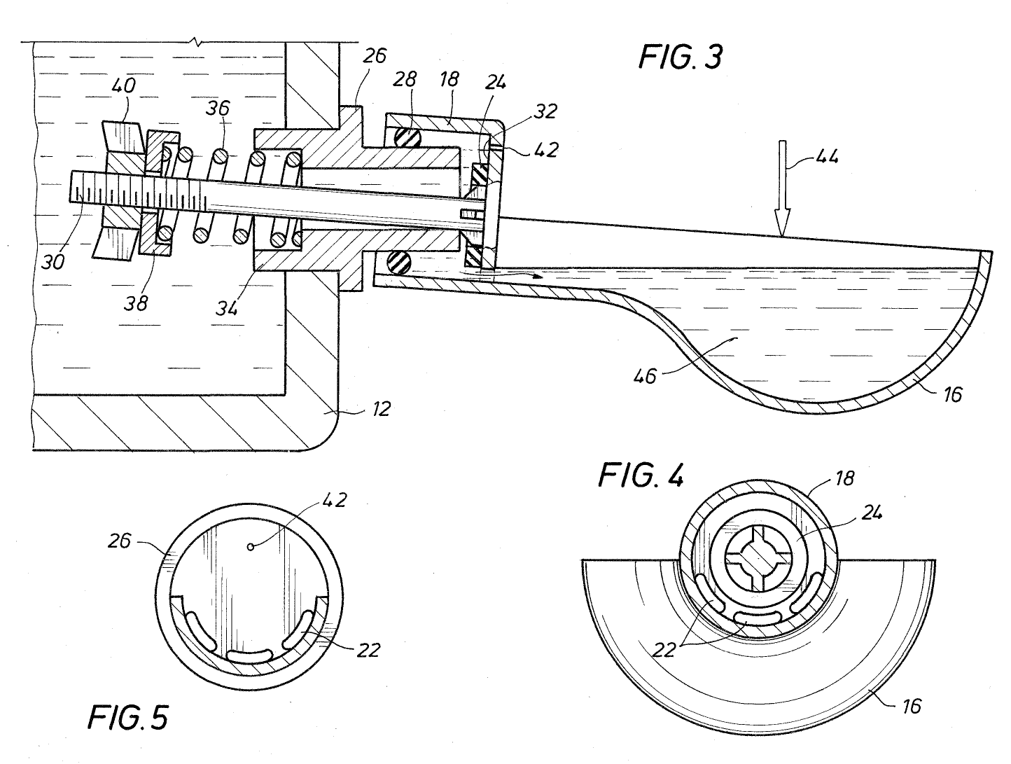

The gasket 24 seals the barrier member 18 to a grommet 26 when the device 10 is in the “rest” or quiescent position, as shown in FIG. 2. The grommet 26 is preferably press fit into the drain plug opening 14, although other mounting means may be used. The grommet 26 includes a first end 25 inside the reservoir 12 and a second end 27 outside the reservoir. Another gasket 28 also seals between the barrier member 18 and the grommet 26. The gasket 28 provides a roller seat with a sealing function, as shown below in respect of FIG. 3. A threaded bolt 30 extends from an inside surface 32 of the barrier member 18 and into the interior of the reservoir 12. The bolt 30 may press fit onto a mating cruciform mount, as shown in FIG. 4, or other appropriate means.

The grommet 26 also extends into the reservoir 12. A cup 34 is formed in the grommet 26 to receive a biasing means 36, such as a compression spring, and the cup 34 holds one end of the spring. Alternatively, the spring may be formed of the same diameter as the end of the grommet and come into abutting contact with the grommet. A cup shaped washer 38 retains the other end of the spring, and the compression force of the spring is set by mounting a wing-nut 40 onto the threaded bolt 30 and screwing it down to the desired position on the bolt threads.

The watering device may further include a vent aperture located near the upper portion of the barrier member to form a conduit between interior of the reservoir and ambient air.

During initial operation, the reservoir contains water and the device is disposed within the drain plug opening, but does not have any water in it, yet. A positive seal is established wherein minimal or no water exits the reservoir through the drain plug opening. As a pet depresses the bowl with its nose, tongue, or the like, as illustrated by an arrow 44 in FIG. 3, the barrier member at the opposite end of the device is displaced slightly to allow a flow of water from the interior of the reservoir through the drain plug opening, through the holes 22, and into the bowl for consumption by the animal. A quantity of water 46 thus flows into the bowl. When the animal is finished drinking of the water 46, and the bowl at the end of the device is no longer depressed, the barrier member at the opposite end of the watering device returns to the closed position and re-establishes a positive seal.

The device is a simple, portable attachment that can be inserted into a variety of containers to provide clean, safe drinking water for all types of animals. The watering device is inexpensive and relatively simple to manufacture, easy to use, and lightweight for travel. In addition, the device prevents excess evaporation from occurring due to large amounts of water exposed to the outside air, thereby providing an adequate supply of fresh water over an extended period of time.

From the above description it is clear that the present invention is well adapted to carry out the objects and to attain the advantages mentioned herein as well as those inherent in the invention. While presently preferred embodiments of the invention have been described for purposes of disclosure, it will be understood that numerous changes may be made which readily suggest themselves to those skilled in the art and which are accomplished within the spirit of the invention disclosed.

I claim:

1. An apparatus for dispensing liquid comprising:
a. a reservoir retaining a quantity of liquid, the reservoir defining an interior wall and an exterior wall, and further defining a drain plug opening;
b. a water dispensing device extending through the drain plug opening, the water dispensing device comprising:
i. a grommet extending through and abutting the drain plug opening, the grommet defining a first end inside the reservoir and a second end outside the reservoir;
ii. a barrier member extending onto the grommet and defining an inside surface;
ii. a first gasket between the grommet and the barrier member;
iii. an upwardly facing bowl extending from the barrier member;
iv. a threaded bolt extending from the inside surface of the barrier member and through the grommet;
v. a spring over the threaded bolt and in abutting contact with the first end of the grommet;
vi. a cup-shaped washer retaining the spring on the threaded bolt; and
v. a nut threaded onto the bolt and in abutting contact with the cup-shaped washer.

2. The apparatus of claim 1, further comprising at least one hole through the barrier member to selectively define a fluid flow path from the reservoir into the bowl.

3. The apparatus of claim 1, further comprising a vent opening through the barrier member.

4. The apparatus of claim 1, further comprising a second gasket between the grommet and the barrier member.

5. The apparatus of claim 1, wherein the first gasket defines a flat washer affixed to the inside surface of the barrier member.

6. The apparatus of claim 1, wherein the bowl and the threaded rod are adapted for fixed relation to one another, and wherein the bowl and threaded rod are adapted for rotational movement within the grommet, as controlled by an animal.

7. An apparatus for dispensing liquid comprising:
a. a reservoir retaining a quantity of liquid, the reservoir defining an interior wall and an exterior wall, and further defining a drain plug opening;
b. a water dispensing device extending through the drain plug opening, the water dispensing device comprising an upwardly facing bowl extending through the drain plug opening, wherein a first position of the bowl prevents flow of the liquid from the reservoir into the bowl, and a second position of the bowl permits flow of the liquid into the bowl.
